(19) United States
(12) Patent Application Publication
(10) Pub. No.: US 2016/0350762 A1
(43) Pub. Date: Dec. 1, 2016

(54) APPARATUS AND METHOD OF VERIFYING A PURCHASE TRANSACTION

(71) Applicant: NCR Corporation, Duluth, GA (US)

(72) Inventor: Mikel Blanchard, Orange, CA (US)

(21) Appl. No.: 14/724,967

(22) Filed: May 29, 2015

(51) Int. Cl. G06Q 20/40; G06Q 20/38

(52) U.S. Cl. CPC G06Q 20/40145; G06Q 20/3825; G06Q 20/405

(57) ABSTRACT

An apparatus and method of verifying a purchase transaction using a customer image. An example method includes capturing an image of a customer during the purchase transaction, and comparing an image provided by a card holder to the image of the customer to determine whether the cardholder is the customer. The example method may further include activating a camera to capture the image of the customer, storing the image in a record of the purchase transaction, receiving a request to reverse the payment by the card holder, obtaining the image of the customer from the record, sending a denial of the request when the image of the customer contains the card holder, and sending an approval of the request when the image of the customer does not contain the card holder.

### BACKGROUND

The present invention relates to point of sale systems and methods, and more specifically to an apparatus and method of verifying a purchase transaction.

During a purchase transaction, a customer may complete payment using a variety of methods. For example, a customer may provide a payment card, such as a credit or debit card. The customer uses a card reader to read payment data from the payment card. For debit card payments, the customer additionally enters a personal identification number (PIN) using a keypad.

Some customers may dispute purchases from merchants for legitimate reasons. For example, a customer may raise a dispute based upon the quality of a good or service being less than desired. As another example, a customer may raise a dispute based upon a mischaracterization of a good or service. As another example, a customer may raise a dispute based upon the customer's payment card data being stolen. The customer often involves the payment card issuer in these disputes.

However, some customers may report not making a purchase when they did in fact make the purchase. Such customers may be forgetful or they may be fraudsters with intent to convince a payment card issuer to reverse a payment. Either way, the customer receives one or more items for free at the merchant's expense.

Therefore, it would be desirable to provide an apparatus and method of verifying a purchase transaction which overcomes these problems.

### SUMMARY

In accordance with the teachings of the present invention, an apparatus and method of verifying a purchase transaction is provided.

An example method includes capturing an image of a customer during the purchase transaction, and comparing an image provided by a card holder to the image of the customer to determine whether the cardholder is the customer. The example method may further include activating a camera to capture the image of the customer, storing the image in a record of the purchase transaction, receiving a request to reverse the payment by the card holder, obtaining the image of the customer from the record, sending a denial of the request when the image of the customer contains the card holder, and sending an approval of the request when the image of the customer does not contain the card holder.

An example payment peripheral includes a display, a card reader, a camera, and a processor configured to activate the camera to capture an image of a customer.

In the example payment peripheral, the processor may be configured to send the image to a storage location containing a record of a corresponding purchase transaction.

In the example payment peripheral, the image may include a payment verification image associating the customer with a purchase transaction.

### BRIEF DESCRIPTION OF THE DRAWINGS

Additional benefits and advantages of the present invention will become apparent to those skilled in the art to which this invention relates from the subsequent description of the preferred embodiments and the appended claims, taken in conjunction with the accompanying drawings, in which:

FIG. 1 is a block diagram of an example system;

FIG. 2 is an example payment peripheral;

FIG. 3 is a flow diagram of an example payment method involving the example payment peripheral of FIG. 2; and

FIG. 4 is a flow diagram of an example payment verification method.

### DETAILED DESCRIPTION

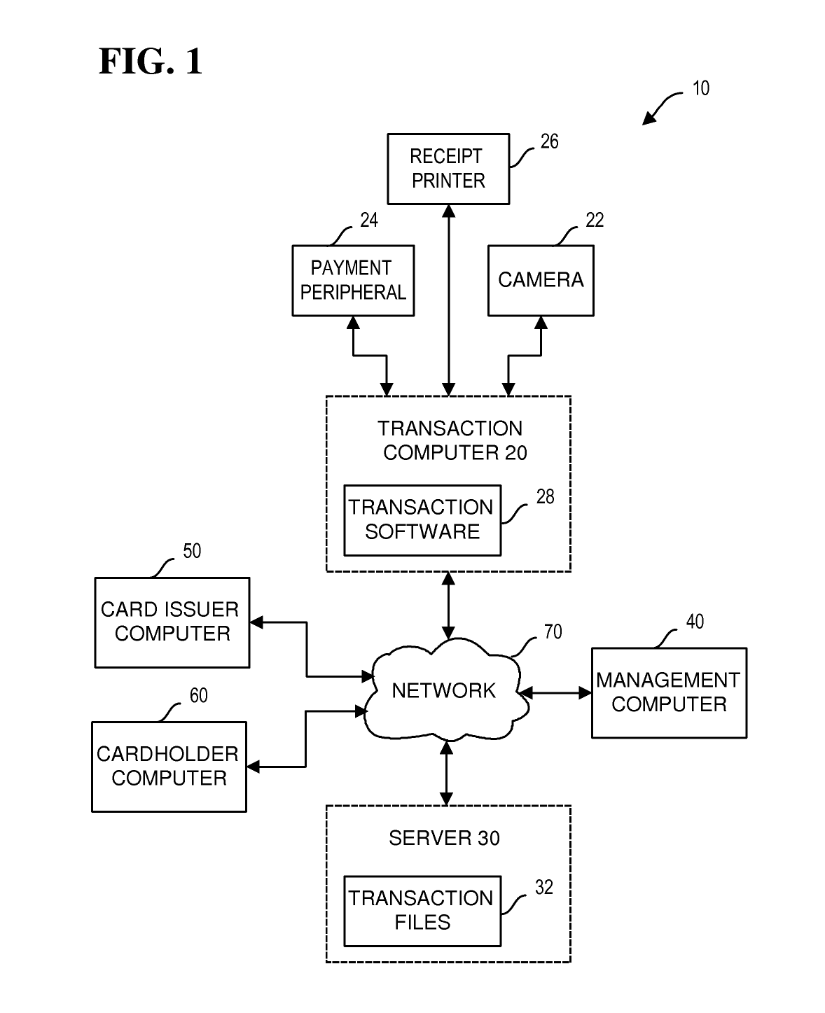

With reference to FIG. 1, an example system 10 includes transaction computer 20 and server 30 connected via network 70. Transaction computer 20 and server 30 are associated with a particular merchant that sells items (goods or services).

Transaction computer 20 may include one or more processors, memory, and program storage. Transaction computer 20 may execute an operating system such as a Microsoft, Linux, Google, or Apple operating system. Transaction computer 20 may be located at a merchant establishment and include any type of computer, such as a personal computer, tablet, or smart phone.

Transaction computer 20 may include a self-service checkout system or an assisted-service checkout system.

Transaction computer 20 may execute software which is stored in a computer readable medium, such as a memory. For example, transaction computer 20 may execute transaction software 28, which records items for purchase and processes payment for the items.

Following each transaction, transaction software 28 may store receipt data at server 30 as part of transaction files 32. In addition to a list of items purchased, example receipt data may include a date and a time the items were purchased, the name of the seller and the seller's address, a seller identification code, an approval code, a reference sequencing number, a terminal identification number, and a portion of the customer's payment card number.

In one example embodiment, transaction software 28 activates camera 22 to capture images at a predetermined point in a transaction. In another example embodiment, a peripheral, such as payment peripheral 24 activates camera 22 at a predetermined point in a transaction. For example, camera 22 may be activated when a customer is using payment peripheral 24. As another example, camera 22 may be activated when payment information is deemed to be valid and accepted. As another example, camera 22 may be activated when a receipt is printed by receipt printer 26. Other examples are envisioned in which camera 22 is activated at other points of a transaction.

Camera 22 is located where a transaction occurs. In one example embodiment, camera 22 may be a stand-alone device. In another example embodiment, camera 22 may integrated within, or mounted to, another device. For example, camera 22 may be combined with a check stand, or a bezel of a touch screen, or with a peripheral, such as payment peripheral 24. Camera 22 may include a charge coupled device (CCD) camera.

Payment peripheral 24 processes customer payments. In one example embodiment, payment peripheral 24 includes a card reader. In another example embodiment, payment peripheral 24 includes a personal identification number (PIN) keypad, and/or other type of device for performing customer authentication, such as a biometric reader. In another example embodiment, payment peripheral 24 includes a signature and/or touch capture pad. In some embodiments, one or more of a card reader, PIN keypad and/or other authentication device, and signature capture pad may be combined into a single payment peripheral 24. Other types and combinations of payment peripherals 24 are also envisioned.

Server 30 may include one or more processors, memory, and program storage. Server 30 may execute an operating system such as a Microsoft, Linux, Google, or Apple operating system. Server 30 may execute software which is stored in a computer readable medium, such as a memory. Server 30 may be located at a transaction establishment or be located remotely, such as “in the cloud”.

Server 30 receives and stores transaction files 32, including receipts and corresponding customer images from transaction terminal 20, on behalf of the merchant. Server 30 also provides requested receipts and customer images to management computer 40 when a customer requests a reversal of a card payment.

Management computer 40 may be operated by the merchant to handle customer complaints. For this purpose, management computer 40 obtains transaction files 32 relevant to a disputed payment from server 30 via network 70. Management computer 40 may also send information from transaction files 32 to resolve a dispute with card issuer computer 50 and/or cardholder computer 60 via network 70.

Management computer 40 may include one or more processors, memory, and program storage. Management computer 40 may execute an operating system such as a Microsoft, Linux, Google, or Apple operating system. Management computer 40 may execute software which is stored in a computer readable medium, such as a memory. Management computer 40 may be located at a merchant establishment and include any type of computer, such as a personal computer, laptop, tablet, or smart phone.

Network 70 may include one which uses the transmission control protocol/internet protocol (TCP/IP). Network 70 may include a combination of local area and wide area networks. Network 70 may include any combination of wireless or wired networks. Network 70 may include a combination of private and public networks, including a global communication network, also known as the Internet. Network may include any combination of wireless technologies, including Wi-Fi, Bluetooth and/or near field communication (NFC) standard circuitry

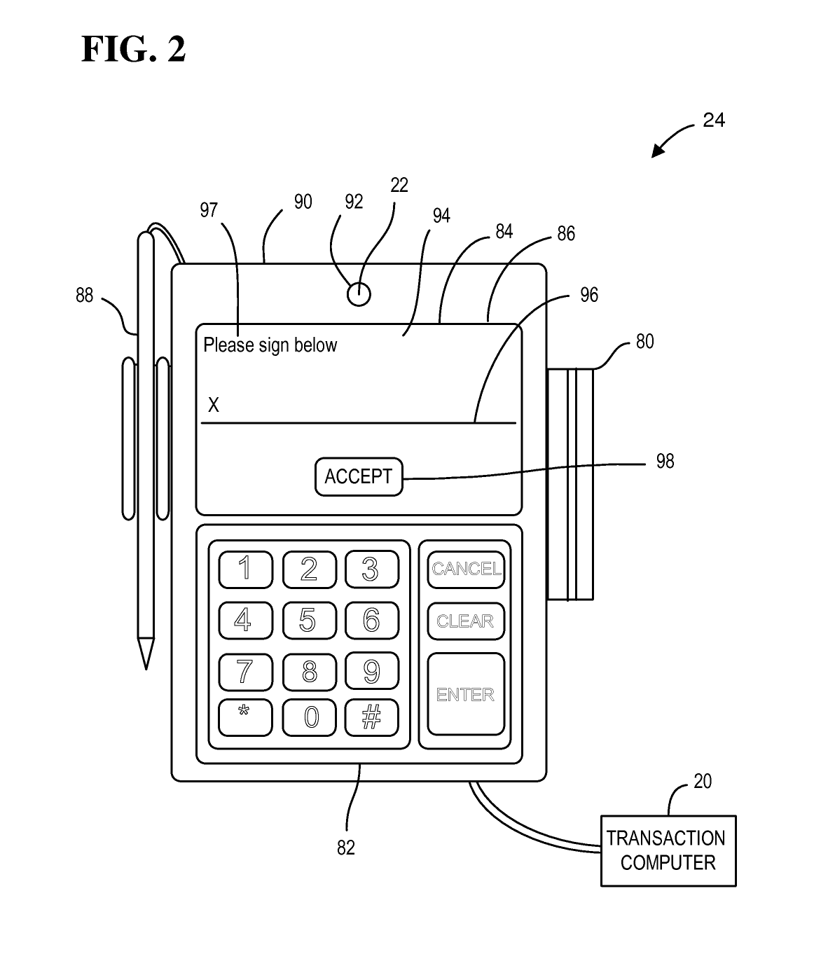

Referring now to FIG. 2, an example payment peripheral 24 is illustrated.

Example payment peripheral 24 may include one or more processors, memory, and program storage. Example payment peripheral 24 may execute an operating system, which may be proprietary to the manufacturer of payment peripheral 24. Example payment peripheral 24 may execute software which is stored in a computer readable medium, such as a memory. For example, example payment peripheral 24 may execute software for completing payment, including displaying payment screens, capturing user-provided inputs or data, encrypting sensitive payment data, and sending payment and other data to transaction computer 20 so that transaction computer 20 may finalize a purchase transaction.

Example payment peripheral includes card reader 80, keypad 82, display 84, signature capture overlay and/or touch sensitive overlay 86, and stylus 88 in a single integrated peripheral device.

Example card reader 80 reads payment and other cards, such as loyalty cards. Example payment cards include credit and debit cards.

Keypad 82, display 84, and signature capture pad 86 are organized within a common housing. Keypad 82 records customer payment selections. During a debit card transaction, keypad 82 additionally records a customer PIN.

Display 84 displays payment screens, including a prompt for signature.

Signature capture overlay 86 captures a customer signature entered using stylus 88. Signature capture overlay 86 may also be configured to captured selections displayed in payment screens.

Example payment peripheral 24 additionally includes integrated camera 22 which captures images of customers. In an example embodiment, camera 22 is located behind bezel 90 and captures images through aperture 92.

In an example mode of operation, payment peripheral 24 is configured to capture a customer image when payment peripheral 24 receives payment card data following customer use of card reader 80.

In another example mode of operation, payment peripheral 24 is configured to capture a customer image when payment peripheral 24 receives PIN data following customer use of keypad 82.

In another example mode of operation, payment peripheral 24 is configured to capture a customer image when payment peripheral 24 receives signature data following customer use of signature capture overlay 86.

Payment peripheral 24 may be configured to capture customer images at one or more of these points of a payment process and at other points of a payment process.

Example payment peripheral 24 may be coupled to transaction computer 20 through a serial connection, such as Universal Serial Bus (USB). As another example, payment peripheral 24 may be coupled to transaction computer 20 through a network connection. Transaction software 28 finalizes the purchase transaction and stores a copy of the receipt, which may include the customer's signature, and the one or more customer images at server 30 in transaction files 32.

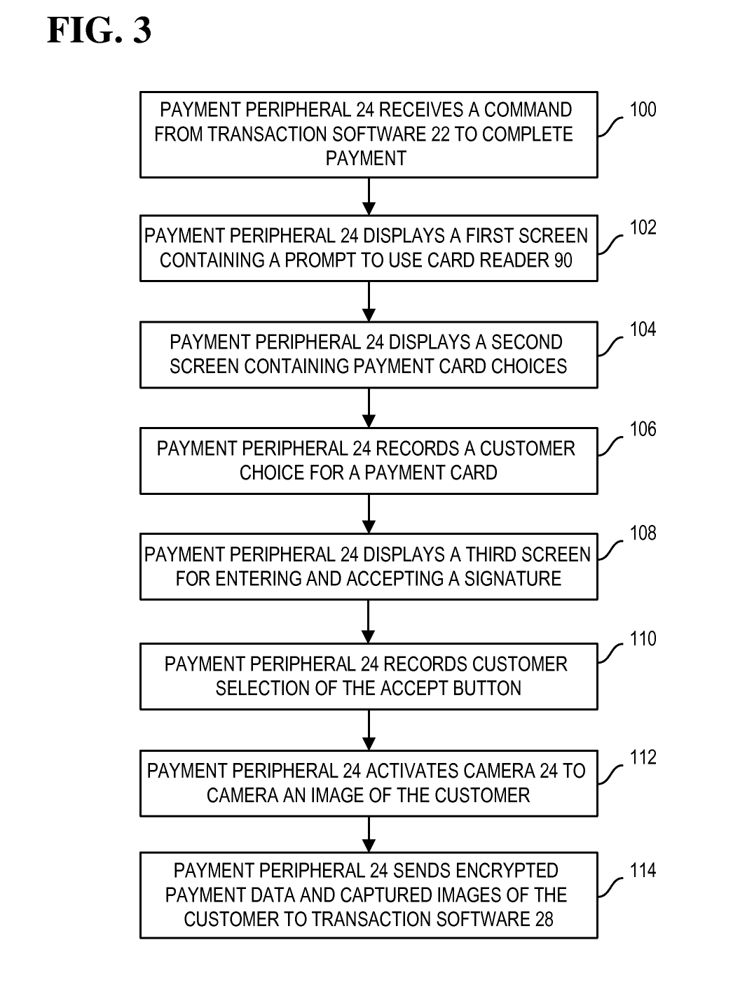

Referring now to FIG. 3, an example payment method using the example payment peripheral 24 of FIG. 2 begins with step 100, in which payment peripheral 24 receives a command from transaction software 22 to complete payment.

In step 102, payment peripheral 24 displays a first screen containing a prompt to use card reader 80 to read a payment card.

After receiving payment card data from card reader 80, payment peripheral 24 displays a second screen containing payment card choices, including credit card and debit card in step 104.

In step 106, payment peripheral 24 records a customer choice for a payment card.

In step 108, payment peripheral 24 displays a third screen 94 (FIG. 2) containing a signature line 96, a prompt to sign 97, and an “accept” button 98 for accepting the terms of the transaction and/or approving payment.

In step 110, payment peripheral 24 records customer selection of the accept button, indicative of the customer having signed.

In step 112, payment peripheral 24 activates camera 22 to camera an image of the customer.

In step 114, payment peripheral 24 sends encrypted payment data and captured images of the customer to transaction software 28.

Transaction software 22 sends the encrypted payment information to a transaction processor to complete payment, and sends receipt data, which may include signature data, and customer images to server 30 to be stored in transaction files 32.

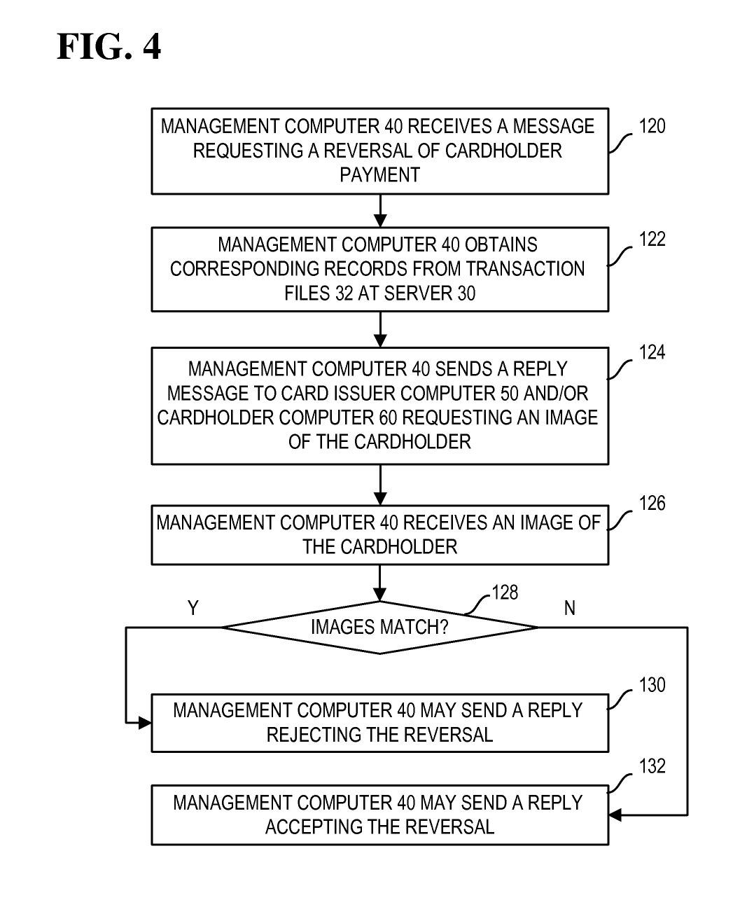

Referring now to FIG. 4, an example purchase transaction verification method begins with step 120, in which management computer 40 receives a message requesting a reversal of cardholder payment for one or more items on the grounds that the cardholder did not purchase the items. In an example embodiment, the message comes from card issuer computer 50 associated with a card issuer and/or cardholder computer 60 associated with the cardholder. The card issuer may act as an advocate on behalf of the cardholder.

The message includes details of the disputed purchase transaction, such as a date and a time the items were purchased, a list of items purchased, and a portion of the customer's payment card number. In one example embodiment, the message is an e-mail message. Other types of electronic messages are envisioned.

In step 122, management computer 40 obtains corresponding records from transaction files 32 at server 30, using the details provided in the message from card issuer computer 50.

In step 124, management computer 40 sends a reply message to card issuer computer 50 and/or cardholder computer 60 requesting an image of the cardholder. In one example embodiment, the reply message is an e-mail message. Other types of electronic messages are envisioned.

In step 126, management computer 40 receives an image of the cardholder from card issuer computer 50 and/or cardholder computer 60.

In step 128, management computer 40 compares the received image to the image associated with the purchase transaction in transaction files 32. If the images match, operation proceeds to step 130. Otherwise, operation proceeds to step 132.

In step 130, management computer 40 may send a reply rejecting the reversal on the grounds that the cardholder is mistaken.

In step 132, management computer 40 may send a reply accepting the reversal on the grounds that the cardholder is correct.

In another embodiment, management computer 40 may send the customer image from transaction files 32 to card issuer computer 50. Card issuer computer 50 may perform a comparison of images instead of, or in addition to, management computer 40.

Although the invention has been described with particular reference to certain preferred embodiments thereof, variations and modifications of the present invention can be effected within the spirit and scope of the following claims.

What is claimed is:

1. A method of verifying a purchase transaction completed using a payment card comprising:
capturing an image of a customer during the purchase transaction; and
comparing an image provided by a card holder to the image of the customer to determine whether the cardholder is the customer.

2. The method of claim 1, further comprising:
activating a camera to capture the image of the customer;
storing the image in a record of the purchase transaction;
receiving a request to reverse the payment by the card holder;
obtaining the image of the customer from the record;
sending a denial of the request when the image of the customer contains the card holder; and
sending an approval of the request when the image of the customer does not contain the card holder.

3. The method of claim 1, wherein activating comprises activating the camera by a transaction terminal associated with the purchase transaction.

4. The method of claim 1, wherein activating comprises activating the camera by a payment device used by the customer during payment.

5. The method of claim 4, wherein activating further comprises activating the camera by the payment device following customer entry of a signature using the payment device.

6. A method of verifying a purchase transaction between a business and a customer using a payment card comprising:
recording a card payment from the customer by a payment device;
activating a camera by the payment device to capture an image of the customer;
sending the image to a storage location containing a record of the purchase transaction by the payment device;
receiving a request to reverse the payment by a card holder as part of a dispute process;
obtaining the image of the customer from the record by a computer associated with the business;
receiving an image of the card holder by the computer associated with the business;
sending a message denying the request when the image of the customer contains the card holder by the computer associated with the business; and
sending a message approving the request when the image of the customer does not contain the card holder by the computer associated with the business.

7. The method of claim 6, wherein the step of receiving a request comprises receiving the request from a card issuer computer.

8. The method of claim 6, wherein the step of receiving an image of the card holder comprises receiving the image of the card holder from a card issuer computer.

9. A payment peripheral comprising:
a display;
a card reader;
a camera; and
a processor configured to activate the camera to capture an image of a customer.

10. The payment peripheral of claim 9, further comprising a signature capture pad, wherein the processor is further configured to activate the camera following entry of a signature by the customer.

11. The payment peripheral of claim 9, wherein the processor is further configured to display a prompt to the customer to accept terms of a purchase transaction and to record a customer entry approving payment.

12. The payment peripheral of claim 9, wherein the processor is further configured to send the image to a storage location containing a record of a corresponding purchase transaction.

13. The payment peripheral of claim 9, wherein the processor is further configured to activate the camera in response to a command from an associated transaction terminal.

14. The payment peripheral of claim 9, wherein the image comprises a payment verification image associating the customer with a purchase transaction.
